(19) United States
(12) Patent Application Publication
(10) Pub. No.: US 2022/0104478 A1
(43) Pub. Date: Apr. 7, 2022

(54) Elastic Mosquito Net for Car Front Side Window

(71) Applicant: Jiing-Duen Enterprise Co., Ltd., Taichung City 429010 (TW)

(72) Inventor: Ching-Duan Chang, Taichung City (TW)

(21) Appl. No.: 17/329,768

(22) Filed: May 25, 2021

(30) Foreign Application Priority Data
Oct. 5, 2020 (TW) 109213035

(51) Int. Cl. A01M 29/34; B60J 11/08

(52) U.S. Cl. CPC A01M 29/34; B60J 11/08

(57) ABSTRACT

An elastic mosquito net for a car front side window is revealed. The elastic mosquito net made of elastic mesh fabric is installed on a window frame of a front door of a car. A mounting hole is disposed on an outer fabric surface of the elastic mosquito net and corresponding to a rear-view mirror for allowing a neck portion of the rear-view mirror to be inserted through. The mounting hole is provided with a drawstring by which users can operate to make the mounting hole wrap and fit to the neck portion closely for preventing mosquitoes and insects from passing through a gap between the mounting hole and the neck portion and the open front side window and then entering the car. The drawstring can be replaced by a separable connecting member which allows users to adjust a length/area thereof being connected for tight and close fit.

### BACKGROUND OF THE INVENTION

### Field of the Invention

The present invention relates to an anti-mosquito accessory for car windows, especially to an elastic mosquito net installed on a car front side window.

### Description of Related Art

A car is a common type of transportation for modern people or families. They often use cars no matter going out for work, for leisure time, or for other uses. Sometimes drivers or passengers need to switch off the engine and keep the window open for good ventilation of the interior of the car based on different reasons. While taking a rest or a snap or playing and chatting in the car, turning-off the engine and opening the windows have different purposes such as energy saving and environmentally friendly, allowing users to breath fresh air outside the car and compliance with regulations.

However, in some occasions or locations the car is parked, mosquitoes and other insects are easily flying into the interior of the car through the open windows and causing great trouble to the driver or passengers in the car. In order to address the above issue, a ventilated mesh for car windows is revealed in Taiwanese Pat. Pub. No. 406642.

The ventilated mesh is made of flexible soft materials and providing good ventilation performance by a plurality of meshes thereof. The ventilated mesh is provided with a mounting opening having a rope on the periphery for covering outside a window frame of a front door of the car. By a through hole with a rope on the periphery and a cut located between the through hole and the mounting opening, a rear-view mirror in the window frame is inserted into the through hole through the open cut. Then the through hole is fitted on a neck part of the rear-view mirror by closing the cut. Thus an opening of the window is enclosed in the ventilated mesh when the window is rolled down and a sufficient degree of protection from mosquitoes is provided. The above cut can be a zipper or a touch fastener which is opened for installation and ventilation and then closed after the operation.

However, the design of the ventilated mesh has certain shortcomings. For example, the ventilated mesh made of flexible soft materials is elastic and able to be applied to window frames with different specifications and shapes. Thus it's easy to install and use. Yet the whole ventilated mesh is easy to have elastic expansion and irregular deformation after the installation so that the through hole is enlarged and deformed, and thus unable to be fitted closely to the neck part of the rear-view mirror.

Moreover, an obvious gap or slit is unavoidably generated between the enlarged or deformed through hole so that mosquitoes and other insects can still get into the car through the opening on top of the window and the gap. Thus the protection against mosquitoes is not as effective as expected. Although the issues vary in degrees depending on the elasticity of the ventilated mesh, the position of the through hole on the ventilation mesh with respect to the position of the rear-view mirror in the window frame and the fit difference between them, and the size and shape of the ventilated mesh relative to those of the window frame and the fit difference between them, the gap issue mentioned above still exists and further affects protection against mosquitoes.

It should be noted that even the periphery of the through hole of the ventilated mesh is provided with the rope for being pulled to tighten the through hole. But the rope is usually an elastic bandage or strap which is unable to withstand the pulling force generated after expansion and deformation of the ventilated bag during installation. Thus elastic deformation unavoidably occurs while being pulled and a larger gap/slit is generated between the through hole and the neck part of the rear-view mirror in the direction being pulled. Therefore, mosquitoes and other insects can fly into the car through the gap/slit, the inner wall of the ventilated mesh and an exterior side of a car door/or the front window, and the opening on top of the window. After being used for a period of time, the common rope/strap may have elastic fatigue and the gap issue mentioned above is getting worse.

The large gap issue mentioned above may be addressed to some degree by customization of the ventilated mesh or replacement of the mesh fabric for the ventilated mesh with non-elastic fabric. Yet there are different types and models of cars provided with front doors having various sizes and specifications. The customization of the ventilated mesh with non-elastic fabric puts a great burden on the product design and development, production and manufacturing, and the following process such as product classification, storage, product sales, etc. This leads to a significant increase in cost and the final price is also increased substantially. The final price set too high is hard for customers to accept.

Moreover, in order to ensure that the through hole of the ventilated mesh can expand elastically for allowing the rear-view mirror to pass through smoothly and the neck part closely fit to the through hole, the ventilated mesh needs to be made of elastic mesh fabric. But there is still a problem of insufficient tightening force caused by elastic fatigue and the problem leads to decrease in tightness/fit between the though hole and the neck portion and further affects the protection against mosquitoes. The ventilated mesh made of non-elastic mesh fabric can avoid the action of elastic fatigue yet the through hole without elasticity is not convenient for installation of the ventilated mesh on the rear-view mirror. An additional design/modification such as the cut mentioned above is required so that cost for material and production is increased and the installation processes are also more complicated. Other issues such as whether the tightness/close-fit of the cut can be maintained may be raised.

Furthermore, refer to Taiwanese Pat. Pub. No. M316822, a car sun shade with protection against mosquitoes is disclosed. The device features on that an extension belt is arranged at each of two sides on the bottom of the car sun shade and a fixing element is disposed on a distal end of the extension belt for fixing the car sun shade on a car door. However, a slot of the car sun shade also has the shortcoming of poor tightness/fit, the same as the through hole of the ventilated mesh mentioned above. The slot of the device is designed into a triangular shape in order to match the shape of the fixing base of the rear-view mirror. Such design is not for close-fit to the neck part of the rear-view mirror and it seems easier to have the gap/slit after installation. Therefore, mosquito protection is not as good as expected.

### SUMMARY OF THE INVENTION

Therefore, it is a primary object of the present invention to provide an elastic mosquito net for a car front side window in which users can operate a drawstring or a separable connecting member around the mounting hole to allow the mounting hole having sufficient shrinkage and tightening force. Thereby the mounting hole is wrapped around and fitted closely to a neck portion of a rear-view mirror of a car for preventing mosquitoes and other insects from passing through a gap between the mounting hole and the neck portion and an opening on top of the front side window and getting into the car. The protection against mosquito bites is achieved.

In order to achieve the above object, an elastic mosquito net for a car front side window according to the present invention is made of elastic mesh fabric and installed on a window frame of a front door of a car. A mounting hole is arranged at an outer fabric surface of the elastic mosquito at the position corresponding to a rear-view mirror for allowing a neck portion of the rear-view mirror to be inserted through. The mounting hole is provided with a drawstring by which users can operate and adjust to make the mounting hole completely wrap around and closely fit to the neck portion. Moreover, the drawstring can be replaced by a separable connecting member which allows users to adjust a length/area of the separable connecting member being connected to make the mounting hole fit closely to the neck portion.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of a car which an embodiment is mounted to and a rear-view mirror is located higher than an upper edge of a front door according to the present invention;

FIG. 2 is a schematic drawing showing an embodiment separated from the front door of the car according to the present invention;

FIG. 3 is a side view of a section of the embodiment along the line 1-1 in FIG. 2 according to the present invention;

FIG. 4 is a perspective view of an embodiment installed on a window frame of the front door of the car in FIG. 2 according to the present invention;

FIG. 5 is a partial perspective view of an embodiment around a mounting hole showing an outer string portion with two separate free ends outside a cord lock according to the present invention;

FIG. 6 is a partial perspective view of an embodiment around a mounting hole showing an outer string portion with a closed structure outside a cord lock according to the present invention;

FIG. 7 is a partial perspective view of another embodiment around a mounting hole showing an outer string portion directly formed by two free ends according to the present invention;

FIG. 8 is a partial perspective view of the embodiment in FIG. 7 showing a knot formed on an outer string portion for allowing users to operate according to the present invention;

FIG. 9 is a partial perspective view of a further embodiment around a mounting hole showing an outer string portion in a closed structure and having a knot for allowing users to operate according to the present invention;

FIG. 10 is a partial perspective view of a fourth embodiment around a mounting hole showing a separable connecting member which is disposed around the mounting hole and composed of a hook fastener and a loop fastener according to the present invention;

FIG. 11 is a partial perspective view of a fourth embodiment around a mounting hole showing a separable connecting member which is disposed around the mounting hole and composed of a first magnetic member and a second magnetic member attached to each other by magnetic force and in a strip form according to the present invention;

FIG. 12 is a partial perspective view of a fourth embodiment around a mounting hole showing a separable connecting member which is disposed around the mounting hole and composed of a plurality of first magnetic members and a plurality of second magnetic members attached to each other by magnetic force and in a block form according to the present invention;

FIG. 13 is a partial perspective view of a fourth embodiment around a mounting hole showing a separable connecting member which is disposed around the mounting hole and composed of a plurality of male fastening parts and a plurality of female fastening parts fastened to each other according to the present invention.

### DETAILED DESCRIPTION OF THE PREFERRED EMBODIMENT

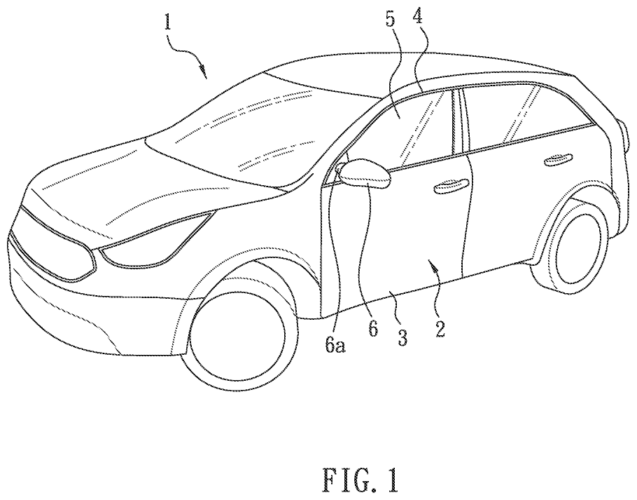

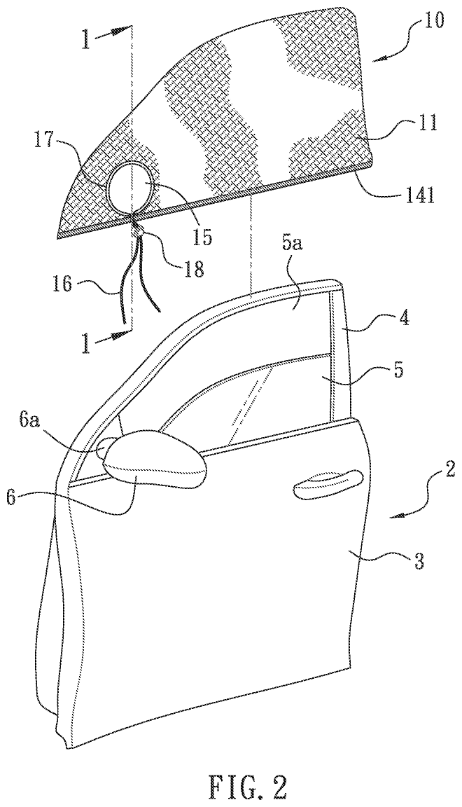

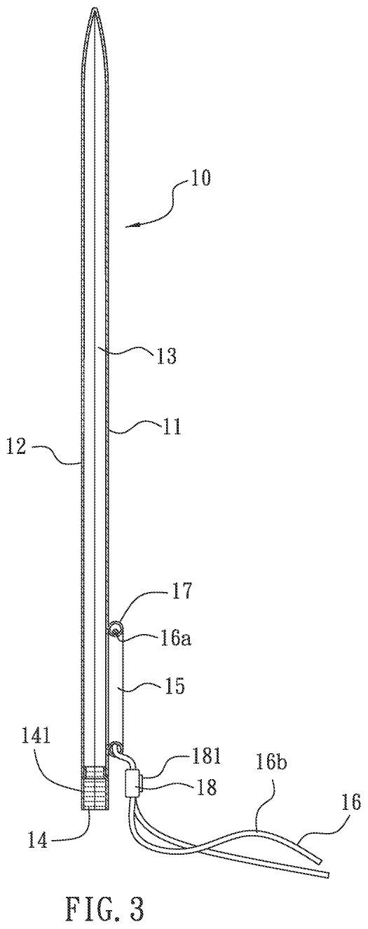

Refer to FIG. 1, FIG. 2 and FIG. 3, an elastic mosquito net for car front side windows according to the present invention is revealed. A front door 2 of a car 1 is provided with an exterior side 3, a window frame 4 on top of the exterior side 3, a front side window 5 mounted in the window frame 4 and able to be raised and lowered, and a rear-view mirror 6 which is located above the exterior side 3 and in the window frame 4. An elastic mosquito net 10 made of elastic mesh fabric is composed of an outer fabric surface 11, an inner fabric surface 12, a mounting space 13 formed between the outer fabric surface 11 and the inner fabric surface 12, and a mounting opening 14 communicating with the mounting space 13. The elastic mosquito net 10 is fitted on the whole window frame 4 by being moved downward with the window frame 4 inserted into the mounting opening 14 so that the whole window frame 4 is mounted in the mounting space 13 completely.

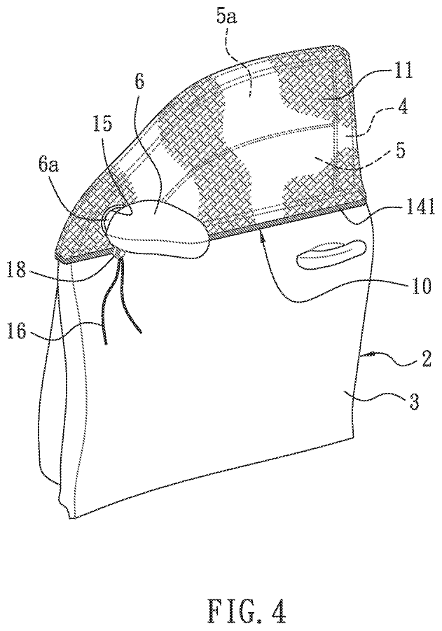

The main improvement of the present elastic mosquito net 10 is that the outer fabric surface 11 of the elastic mosquito net 10 is provided with a mounting hole 15 at the position corresponding to the rear-view mirror 6. As shown in FIG. 4, the mounting hole 15 through which a neck portion 6a of the rear-view mirror 6 is inserted and held is provided with a drawstring 16 able to be operated by users for adjustment of the size of the mounting hole 15. The drawstring 16 can be pulled tight to make the mounting hole 15 not only completely wrap around but also closely fit to the neck portion 6a. Therefore, the elastic mosquito net 10 effectively prevents mosquitoes and other insects from getting into the car 1 through a gap between the mounting hole 15 and the neck portion 6a and an opening 5a on top of the front side window 5.

Moreover, the size of the mounting hole 15 can be modified freely according to the actual size of the rear-view mirror 6 and the neck portion 6a for being tightened. Thus the mounting hole 15 is wrapped around and fitted closely to an outer wall of the neck portion 6a and maintained at the closely-fit state mentioned above, without being affected by the position or size of the neck portion 6a. Thus the mounting hole 15 is not easy to have gradually reduced tightness caused by elastic fatigue after being used for a period of time as the conventional design has. By free adjustment and operation of the mounting hole 15, sufficient tightening of the drawstring 16 and the mounting hole 15 are provided to ensure close fit between the mounting hole 15 and the neck portion 6a, without generating any gap therebetween. Thereby the expected protection against mosquito bites is achieved.

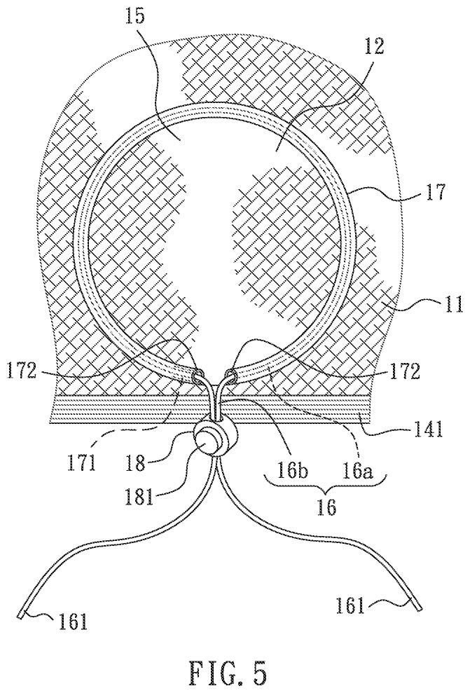

As shown in FIG. 5, a circular string insertion portion 17 is formed around the mounting hole 15 and provided with a string passage 171 mounted in the string insertion portion 17 and two insertion ports 172 which are formed at preset positions, corresponding to each other, and communicating with the string passage 171. A part of the drawstring 16 inserted through and hidden inside the string passage 171 is defined as an inner string portion 16a while the rest part of the drawstring 16 passed through the insertion ports 172 and exposed is defined as an outer string portion 16b. Users can perform adjustment and tightening operations through the outer string portion 16b.

In this embodiment, a cord lock 18 is arranged at the outer string portion 16b. By pushing in the cord lock 18, the cord lock 18 is adjusted and positioned at the outer string portion 16b to hold the outer string portion 16b in place. Thereby easy and fast adjustment, maintaining the size and tightening of the mounting hole 15 are achieved.

It should be point out that the cord lock 18 is a common accessory for users to push in to tighten or loosen cords/strings. When users push a toggle 181 of the cord lock 18 in, the outer string portion 16b run through the cord lock 18 is released and the cord lock 18 can be moved and adjusted freely up and down the outer string portion 16b. Along with the adjustment of the position of the cord lock 18, the size of the mounting hole 15 is also adjusted and controlled to be tightened or loosened. After the adjustment of the position of the cord lock 18, users only need to release the toggle 181 so that the outer string portion 16b is engaged and held by the cord lock 18 automatically due to restoring force of elastic components inside the cord lock 18 such as springs. Thereby both the size and the tightening of the mounting hole 15 are retained well.

In this embodiment, the outer string portion 16b includes two separate free ends 161 at the outside of the cord lock 18. It should be easy to understand that the outer string portion 16b is formed by two strings with preset length as a part of the drawstring 16 and exposed outside the string passage 171 and the free end 161 is formed on each of the above string.

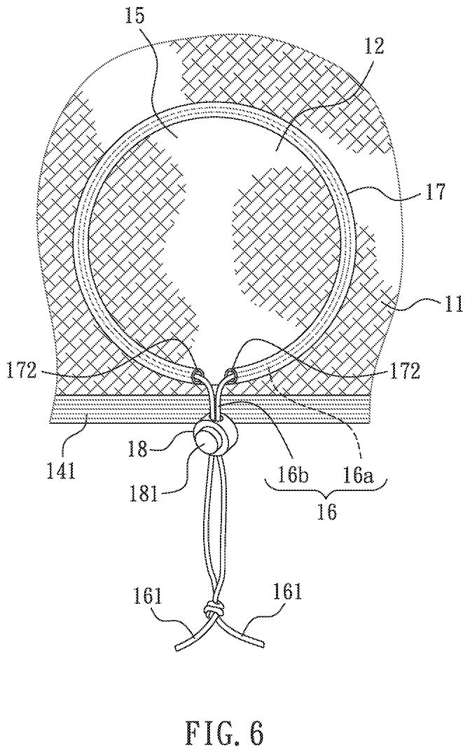

As shown in FIG. 6, the outer string portion 16b outside the cord lock 18 can be a closed structure formed by the two free ends 161 connected to each other. For example, the closed structure can be achieved by a plurality of common techniques available such as a knot, adhesion and fixation, melted connection induced by burning partially, arrangement of a connector, etc. The advantage of the closed structure is in that users can still operate and move the cord lock 18 smoothly, without being affected by the outer string portion 16b in a closed form. The closed form also ensures that the cord lock 18 will not come off the outer string portion 16b and even lose due to careless operation or other uncontrolled factors.

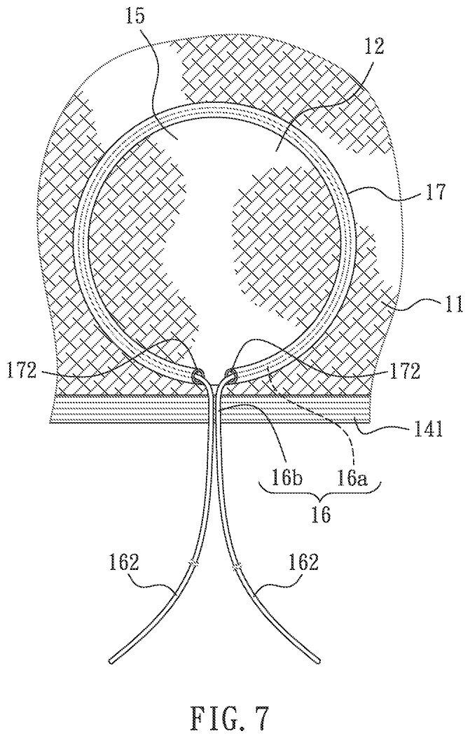

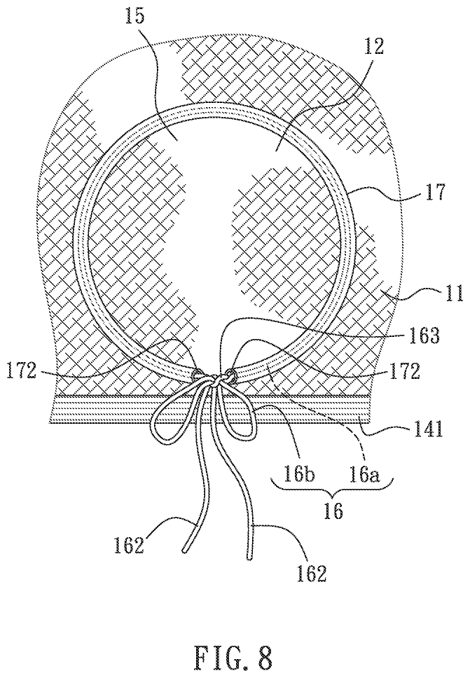

As shown in FIG. 7, another embodiment of an elastic mosquito net for a car front side window according to the present invention is disclosed. This embodiment is similar to the above one and the only difference between the two embodiments is in that this embodiment is not provided with the cord lock 18 on the outer string portion 16b. To be more precisely, the outer string portion 16b of the present embodiment is directly formed by two separated free ends 162, allowing users to tie and get a knot 163 in the form of a slip knot or a dead knot. As shown in FIG. 8, the mounting hole 15 is adjusted and tightened to fit closely to the neck portion 6a. The knot 163 is used for fixation to keep the size and the tightening of the mounting hole 15 after adjustment.

It is well known that users usually need to pull and bind the free ends 162 for allowing the mounting hole 15 to fit the neck portion 6a closely before formation of the knot 163. Then the mounting hole 15 is effectively maintained at the above close-fit and tightening state by the knot 163. Consumers know how to tie the knot 163 well and there are many different ways available to tie the knot 163 now. It should be understood that the knot 163 can be used as long as it provides expected tight and close-fit, no matter the knot 163 is a dead knot or a slip one.

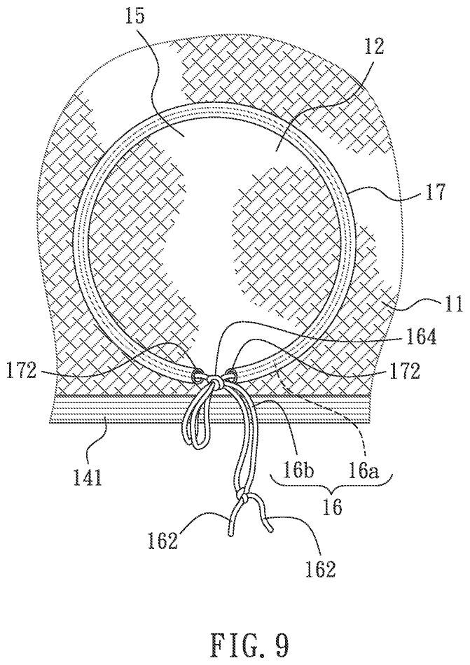

As shown in FIG. 9, a further embodiment of an elastic mosquito net for a car front side window according to the present invention is disclosed. The embodiment is similar to the second one and the only difference between the two embodiments is in that the outer string portion 16b of the present embodiment is closed and allowing users to tie and get a knot 164 which is either a slip knot or a dead knot. The way to form the closed structure has already been explained in the first embodiment. Moreover, the knot 164 of the present embodiment provides the same tight and close fit as the second embodiment. The only difference is in that the present embodiment has the closed structure while the free ends 162 of the second embodiment are in an open structure. There are no limits on the ways to tie the knot 164, as long as the tight and close fit provided by the knot 164 remain.

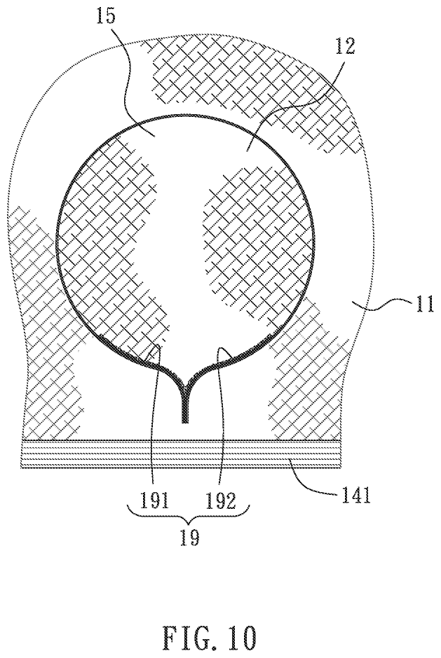

As shown in FIG. 10, a further embodiment of an elastic mosquito net for a car front side window according to the present invention is disclosed. The difference between this embodiment and the above embodiments is in that a separable connecting member 19 is used to replace a combination of the drawstring 16 with the circular insertion potion 17. In other words, at least a part of the periphery of the mounting hole 15 is provided with the separable connecting member 19 which allows users to operate and adjust an area of the separable connecting member 19 being connected for adjusting and shrinking the mounting hole 15 until the mounting hole 15 being completely wrapped around and closely fitted to the neck portion 6a. Thereby the prevention of mosquito bites in this embodiment is similar or close to the above embodiments.

It should be easily understood that the separable connecting member 19 has a plurality of embodiments. In a preferred embodiment, the separable connecting member 19 includes a hook fastener 191 and a loop fastener 192 attached and fastened to each other and users can adjust an area where the hook fastener 191 and the loop fastener 192 are in contact with each other.

To put it simple, the hook fastener 191 and the loop fastener 192 can be fixed on the periphery of the mounting hole 15 by sewing or other ways and arranged at two sides corresponding to each other. Then the hook fastener 191 and the loop fastener 192 originally connected are peeled apart by users to adjust and enlarge the size of the mounting hole 15. On the other hand, the mounting hole 15 can be adjusted and shrunk when the hook fastener 191 and the loop fastener 192 are attached to each other to a greater extent or in a larger area by the user. Thereby the tight and close fit which is quite close or similar to the above embodiments is provided, although to a different extent.

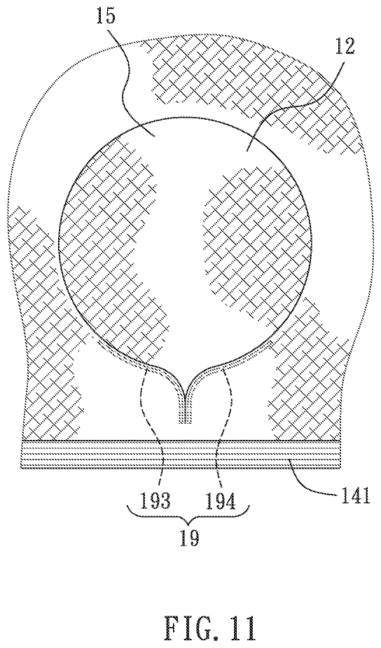

As shown in FIG. 11, another embodiment of the separable connecting member 19 is revealed. The separable connecting member 19 consists of at least one first magnetic member 193 and at least one second magnetic member 194 attached to each other by magnetic force and users can operate and adjust an area where the first and the second magnetic members 193, 194 are magnetically connected to each other.

The difference between the above two embodiments is in that one is connected by hooks caught in loops while the other is connected by magnetic attraction. Moreover, a long and flexible magnetic strip is enclosed and fixed in each of two corresponding positions on the periphery of the mounting hole 15 to form the first magnetic member 193 and the second magnetic member 194. When the two magnetic strips are getting closer to each other, sufficient magnetic attraction is generated to connect them and then the expected tight and close fit is achieved. The degree of close-fit is associated with the magnetic force of the magnetic strip itself in some degree so that the magnetic strip with suitable magnetic force should be selected during the design process.

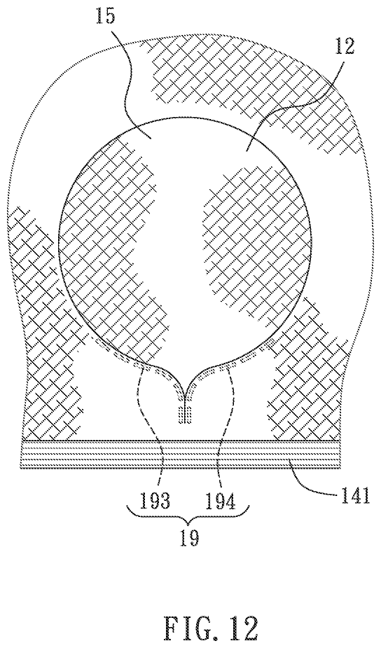

As shown in FIG. 12, a plurality of magnetic blocks are enclosed and fixed in each of the two corresponding parts on the periphery of the mounting hole 15 to form a plurality of the first magnetic member 193 and a plurality of the second magnetic member 194 for providing the same magnetic connection. The difference of this embodiment is only in that a certain interval is formed between the two adjacent magnetic blocks so that the magnetic blocks are difficult to be adjusted for the same tight and close fit to the neck portion 6a with different sizes. The fit to the neck portion 6a is sometimes a bit tighter, sometimes a bit looser. Moreover, the elastic mesh fabric itself makes the mounting hole 15 have certain elasticity. Thus the magnetic blocks are allowed to attach to each other by magnetic force in a larger area than the expected due to the elasticity of the mounting hole 15. Thereby the tight and close fit matches the basic requirements.

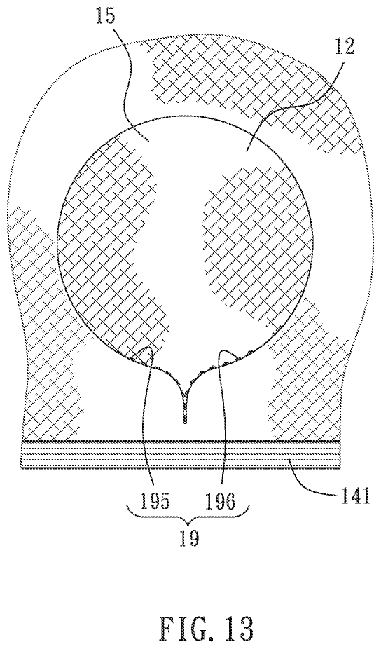

Refer to FIG. 13, a further embodiment of the separable connecting member 19 is revealed. The separable connecting member 19 consists of a plurality of male fastening parts 195 and a plurality of female fastening parts 196, allowing users to adjust and operate the number of the male and female fastening parts 195, 196 fastened to each other. It is easily understood that the difference between this embodiment and the above one formed by a plurality of the first magnetic member 193 and a plurality of the second magnetic member 194 is in that the magnetic attraction is replaced by fastening connection. Although there is a certain interval formed between the two adjacent male fastening parts 195 or female fastening parts 196, the tight and close fit which satisfies the basic requirements can still be achieved.

In addition, a conventional elastic strap 141 is disposed on the periphery of the mounting opening 14 of the respective embodiments mentioned above to enhance elastic compression force of the mounting opening 14 for being attached to an outer surface of the exterior side 3 more closely.

In summary, the present elastic mosquito net 10 has the following features and functions:
1. Excellent and long lasting protection against mosquitoes: by adjustment of the size of the mounting hole 15, users can ensure that the mounting hole 15 is effectively shrunk to completely wrap around and closely fit to the neck portion 6a of the rear-view mirror 6 and no gap left between the mounting hole 15 and the neck portion 6a. Thereby the present device provides better protection against mosquito bites than conventional one and the protection effect is long-lasting, without being affected by easy elastic fatigue of the materials.
2. Easy-and-fast adjustment/operation: after the neck portion 6a of the rear-view mirror 6 being mounted into the mounting hole 15, users only need to push in the cord lock 18 and pull the outer string portion 16b at the same time for shrinking the mounting hole 15 and close-fit of the mounting hole 15 to the neck portion 6a. In other embodiments, the easy-and-fast adjustment/operation can also be achieved by the common knots 163, 164, the hook and loop fasteners 191, 192 connected, the first and second magnetic members 193, 194 magnetically attached to each other, or male and female fastening parts 195, 196 connected to each other by fastening connection.
3. Simple structure and low cost: the expected purposes and functions mentioned above can be achieved by easy sewing of common elastic mesh fabric in combination with common parts such as the drawstring 16, the cord lock 18, the hook and loop fasteners 191, 192, the first and second magnetic members 193, 194, the male and female fastening parts 195, 196, etc. The common parts are not special products so that additional tooling, processing and manufacturing are not required. Thereby the cost for the materials and the assembling is low, the product is competitive, and consumers are more receptive to the product.
4. Wide applicability: the elastic mosquito net 10 made of elastic mesh fabric has certain elasticity. Once the difference in size/specification/shape of the window frame 4 is within the tolerance permitted, it can be overcome by using elasticity of the elastic mosquito net 10. Moreover, the mounting hole 15 can be adjusted within a certain range by the drawstring 16 according to actual conditions such as the size and the position of the neck portion 6a relative to the mounting hole 15 after the mounting hole 15 being fitted to the neck portion 6a of the rear-view mirror 6. Thereby the elastic mosquito net 10 with single specification/size can be widely applied to various car types or car models with similar front doors. Compared with customized products, the present device not only significantly reduces product specification and quantity, but also brings great benefits to product design, production and manufacturing, and the following marketing management. Therefore, the product is more competitive.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

1. An elastic mosquito net made of elastic mesh fabric and applied to a car which includes at least one front door provided with an exterior side, a window frame on top of the exterior side, a front side window mounted in the window frame and able to be raised and lowered, and a rear-view mirror located above the exterior side and in the window frame comprising:
an outer fabric surface, an inner fabric surface, a mounting space formed between the outer fabric surface and the inner fabric surface, and a mounting opening communicating with the mounting space; the elastic mosquito net is fitted on the window frame by being moved downward with the window frame inserted into the mounting opening so that the window frame is enclosed in the mounting space completely;
wherein a mounting hole through which a neck portion of the rear-view mirror is inserted and held is arranged at the outer fabric surface of the elastic mosquito net and corresponding to the rear-view mirror; the mounting hole is provided with a drawstring which is operable to adjust and shrink the mounting hole and make the mounting hole completely wrap around and closely fit to the neck portion for preventing mosquitoes and other insects from getting into the car through a gap between the mounting hole and the neck portion and an opening on top of the open front side window.

2. The elastic mosquito net for a car front side window as claimed in claim 1,
wherein a circular string insertion portion is formed around the mounting hole and provided with a string passage mounted in the string insertion potion and two insertion ports formed at preset positions, corresponding to each other and communicating with the string passage; a part of the drawstring is inserted through and hidden inside the string passage to form an inner string portion while the rest part of the drawstring is passed through the insertion port and exposed to form an outer string portion; the mounting hole is adjustable and shrinkable by operation of the outer string portion.

3. The elastic mosquito net for a car front side window as claimed in claim 2, wherein a cord lock is arranged at the outer string portion; by pushing in the cord lock, the cord lock is able to be adjusted and positioned at the outer string portion to hold the outer string portion in place for adjustment and maintenance of size of the mounting hole.

4. The elastic mosquito net for a car front side window as claimed in claim 3, wherein the outer string portion includes two separate free ends formed outside the cord lock.

5. The elastic mosquito net for a car front side window as claimed in claim 3, wherein the outer string portion outside the cord lock is a closed structure.

6. The elastic mosquito net for a car front side window as claimed in claim 2, wherein the outer string portion is provided with two free ends able to tie and form a knot; thus the mounting hole is adjusted and shrunk to wrap around and fit to the neck portion closely and the knot is used for fixation to keep the size and tightening of the mounting hole.

7. The elastic mosquito net for a car front side window as claimed in claim 2, wherein the outer string portion outside the cord lock is a closed structure and operable to form a knot; thus the mounting hole is adjusted and shrunk to wrap around and fit to the neck portion closely and the knot is used for fixation to keep the size and tightening of the mounting hole.

8. The elastic mosquito net for a car front side window as claimed in claim 1,
wherein an elastic strap is disposed on the periphery of the mounting opening.

9. An elastic mosquito net made of elastic mesh fabric and applied to a car which includes at least one front door provided with an exterior side, a window frame on top of the exterior side, a front side window mounted in the window frame and able to be raised and lowered, and a rear-view mirror located above the exterior side and in the window frame comprising:
an outer fabric surface, an inner fabric surface, a mounting space formed between the outer fabric surface and the inner fabric surface, and a mounting opening communicating with the mounting space; the elastic mosquito net is fitted on the window frame by being moved downward with the window frame inserted into the mounting opening so that the window frame is enclosed in the mounting space completely;
wherein a mounting hole through which a neck portion of the rear-view mirror is inserted and held is disposed on the outer fabric surface of the elastic mosquito net and corresponding to the rear-view mirror; a separable connecting member is mounted to at least a part of the periphery of the mounting hole; an area of the separable connecting member being connected is operable and adjustable to adjust and shrink the mounting hole until the mounting hole being completely wrapped around and closely fitted to the neck portion for preventing mosquitoes and other insects from getting into the car through a gap between the mounting hole and the neck portion and an opening on top of the open front side window.

10. The elastic mosquito net for a car front side window as claimed in claim 9, wherein the separable connecting member includes a hook fastener and a loop fastener attached and fastened to each other; an area where the hook fastener and the loop fastener are in contact with each other is adjustable and operable.

11. The elastic mosquito net for a car front side window as claimed in claim 9, wherein the separable connecting member includes at least one first magnetic member and at least one second magnetic member attached to each other by magnetic force; an area where the first magnetic member and the second magnetic member are magnetically attached to each other is adjustable and operable.

12. The elastic mosquito net for a car front side window as claimed in claim 9, wherein the separable connecting member includes a plurality of male fastening parts and a plurality of female fastening parts; the number of the male fastening part and the number of the female fastening part fastened to each other are adjustable and operable.

13. The elastic mosquito net for a car front side window as claimed in claim 9, wherein an elastic strap is disposed on the periphery of the mounting opening.
